(19) United States
(12) Patent Application Publication
(10) Pub. No.: US 2026/0059233 A1
(43) Pub. Date: Feb. 26, 2026

(54) ACOUSTIC SYSTEM AND IN-VEHICLE COMMUNICATION SUPPORT SYSTEM

(71) Applicant: ALPS ALPINE CO., LTD., Tokyo (JP)

(72) Inventor: Takeru SONOBE, Fukushima (JP)

(21) Appl. No.: 19/256,780

(22) Filed: Jul. 1, 2025

(30) Foreign Application Priority Data
Aug. 22, 2024 (JP) 2024-140935

(51) Int. Cl. H04R 1/32; H04R 1/34

(52) U.S. Cl. CPC H04R 1/323; H04R 1/345

(57) ABSTRACT

An acoustic system and an in-vehicle communication support system that increase the audible sound reproduction level of a parametric loudspeaker while mitigating disadvantages of ultrasonic radiation are provided. An ultrasonic wave amplitude-modulated with audible sound, emitted from a parametric loudspeaker enter an audible sound collector with a high directivity. Of incident ultrasonic wave and incident audible sound self-demodulated from the ultrasonic wave, the audible sound collector attenuates the ultrasonic wave, and reflects the audible sound to be collected at a position near the user. The audible sound collector can be composed of: a reflector having a reflecting surface formed of a paraboloid of revolution; and a sound absorber for absorbing an ultrasonic wave. The sound absorber can be composed of a sound absorbing material made of a phononic crystal, or of resonance tubes.

### CROSS-REFERENCE TO RELATED APPLICATION

The present application claims priority under 35 U.S.C. § 119 to Japanese Patent Application No. 2024-140935, filed Aug. 22, 2024, the contents of which are incorporated herein by reference in their entireties.

### BACKGROUND OF THE INVENTION

### Field of the Invention

The present disclosure relates to a technology for performing local reproduction using a parametric loudspeaker.

### Description of the Related Art

A parametric loudspeaker technology known as a technology for performing local reproduction using a parametric loudspeaker radiates an ultrasonic wave by amplitude-modulating an ultrasonic wave signal with an audible sound signal and driving a high-directivity ultrasonic transducer array by the amplitude-modulated signal, thereby reproducing the audible sound with a high directivity as an audible sound self-demodulated while the ultrasonic wave propagates in the air (for example, Japanese Patent Application Laid-Open Publication No. 2011-234248).

Another known technology makes the direction of the directivity of such a parametric loudspeaker variable and controls the direction of the directivity (for example, Japanese Patent Application Laid-Open Publication No. 2004-349816). Yet another known technology causes an ultrasonic wave that is radiated with amplitude modulation with an audible sound signal to be reflected on a reflector having a paraboloid of revolution or an ellipsoid of revolution as a reflecting surface so as to be collected as a sound at a position near the user to reproduce the audible sound (for example, Japanese Patent Application Laid-Open Publications No. 2003-158788 and H07-107588).

A technology known to be related to the present disclosure is a sound absorbing material composed of a phononic crystal that absorbs only ultrasonic components radiated from a parametric loudspeaker (Akiko SUGAHARA, Hyojin LEE, Shinichi SAKAMOTO, and Shigeto TAKEOKA, “Study to Reduce the Influence of Ultrasound on the Measurement of the Acoustic Properties of Architectural Materials by Using a Parametric Loudspeaker”, Proceedings of the Autumn Research Presentation Meeting of the Acoustical Society of Japan, pp. 1061-1062, September 2017).

Other technologies known to be related to the present disclosure include an ultrasonic wave absorbing material having a cell structure (for example, Registered Japanese Utility Model No. 3128029), and a technology for arraying closed resonance tubes opened at one side and closed at the other side and absorbing noise in the resonance frequency range of the resonance tubes (for example, Japanese Patent Application Laid-Open Publication No. H07-302087).

### SUMMARY OF THE INVENTION

In general, there are problems to be solved in the parametric loudspeaker reproduction of an audible sound via an ultrasonic wave.

That is, there are problems such as that the level of an audible sound to be reproduced is low relative to the level of the ultrasonic wave, that an ultrasonic wave of a high level is radiated to the user, and that an audible sound is undesirably reproduced at the destination to which the ultrasonic wave is reflected.

It is possible to mitigate the audible sound level problem by providing a reflector for collecting the ultrasonic wave radiated from the parametric loudspeaker as a sound, at a position near the user. However, in such a case, there occur problems that an ultrasonic wave of a higher level is radiated to the user, and that an audible sound via an ultrasonic wave of a higher level is reproduced at the destination to which the ultrasonic wave is reflected.

Accordingly, an object of the present disclosure is to increase the level of audible sound reproduction while mitigating disadvantages caused by radiation of an ultrasonic wave in the parametric loudspeaker reproduction of an audible sound via an ultrasonic wave.

In order to achieve the object, an acoustic system including a parametric loudspeaker configured to emit an ultrasonic wave modulated with an audible sound as an emitted sound wave further includes an audible sound collector to which the emitted sound wave emitted by the parametric loudspeaker becomes incident. The audible sound collector includes: a reflector having a reflecting surface configured to reflect a sound wave that becomes incident thereto in a same direction as a direction in which the emitted sound wave becomes incident thereto; and a sound absorber. The sound absorber is positioned closer to a side from which the emitted sound wave becomes incident than the reflecting surface of the reflector is, and is configured to attenuate an ultrasonic wave component of the emitted sound wave reaching the reflecting surface. The reflecting surface of the reflector reflects an audible sound component that is self-demodulated by the emitted sound wave and becomes incident to the audible sound collector, to cause the audible sound component to be collected at a predetermined sound collection position.

In this acoustic system, the reflecting surface of the reflector may have a shape of a paraboloid of revolution.

In the acoustic system, the sound absorber may be a sound absorbing material made of a phononic crystal for absorbing an ultrasonic wave.

In the acoustic system, the sound absorber may include a plurality of closed resonance tubes configured to absorb an ultrasonic wave.

In the acoustic system, the sound collection position may be located in a direction deviated from the direction in which the emitted sound wave becomes incident to the audible sound collector.

In addition, the present disclosure also provides an in-vehicle communication support system to be mounted on an automobile, including the above-described acoustic system. The in-vehicle communication support system includes a microphone configured to collect uttered voice of a user seated in a first seat of the automobile. The parametric loudspeaker emits an ultrasonic wave modulated with the uttered voice collected by the microphone as the emitted sound wave. The sound collection position at which the audible sound collector of the acoustic system collects the audible sound component is a position near a user seated in a second seat of the automobile.

According to the above-described acoustic system, it is possible to increase the level of only an audible sound because the reflecting surface collects the audible sound component at the sound collection position with the ultrasonic wave component absorbed by the sound absorber of the audible sound collector such that the arrival of the ultrasonic wave component at the reflecting surface is inhibited. Therefore, the problems, such as radiation of an ultrasonic wave of a higher level to the user, and reproduction of an audible sound via an ultrasonic wave of a higher level at the destination to which the ultrasonic wave is reflected, are avoided.

As described above, according to the present disclosure, it is possible to increase the level of audible sound reproduction while mitigating disadvantages caused by radiation of an ultrasonic wave in the parametric loudspeaker reproduction of an audible sound via an ultrasonic wave.

### BRIEF DESCRIPTION OF THE DRAWINGS

FIG. 1 is a diagram showing the configuration of an acoustic system according to an embodiment of the present disclosure;

FIG. 2A is a diagram showing an example of the configuration of an audible sound collector according to an embodiment of the present disclosure;

FIG. 2B is a diagram showing an example of the configuration of an audible sound collector according to an embodiment of the present disclosure;

FIG. 2C is a diagram showing an example of the configuration of an audible sound collector according to an embodiment of the present disclosure;

FIG. 2D is a diagram showing an example of the configuration of an audible sound collector according to an embodiment of the present disclosure;

FIG. 2E is a diagram showing an example of the configuration of an audible sound collector according to an embodiment of the present disclosure;

FIG. 2F is a diagram showing an example of the configuration of an audible sound collector according to an embodiment of the present disclosure;

FIG. 2G is a diagram showing an example of the configuration of an audible sound collector according to an embodiment of the present disclosure;

FIG. 3A is a diagram showing an example of the configuration of an audible sound collector according to an embodiment of the present disclosure;

FIG. 3B is a diagram showing an example of the configuration of an audible sound collector according to an embodiment of the present disclosure;

FIG. 3C is a diagram showing an example of the configuration of an audible sound collector according to an embodiment of the present disclosure;

FIG. 3D is a diagram showing an example of the configuration of an audible sound collector according to an embodiment of the present disclosure;

FIG. 3E is a diagram showing an example of the configuration of an audible sound collector according to an embodiment of the present disclosure;

FIG. 3F is a diagram showing an example of the configuration of an audible sound collector according to an embodiment of the present disclosure;

FIG. 4 is a diagram showing an example of an application of an acoustic system according to an embodiment of the present disclosure;

FIG. 5A is a diagram showing an example of an application of an acoustic system according to an embodiment of the present disclosure;

FIG. 5B is a diagram showing an example of an application of an acoustic system according to an embodiment of the present disclosure;

FIG. 6 is a diagram showing an example of an application of an acoustic system according to an embodiment of the present disclosure;

FIG. 7A is a diagram showing an example of an application of an acoustic system according to an embodiment of the present disclosure;

FIG. 7B is a diagram showing an example of an application of an acoustic system according to an embodiment of the present disclosure;

FIG. 8A is a diagram showing an example of an application of an acoustic system according to an embodiment of the present disclosure;

FIG. 8B is a diagram showing an example of an application of an acoustic system according to an embodiment of the present disclosure;

FIG. 9A is a diagram showing another example of the configuration of an acoustic system according to an embodiment of the present disclosure; and

FIG. 9B is a diagram showing another example of the configuration of an acoustic system according to an embodiment of the present disclosure.

### DETAILED DESCRIPTION OF THE DISCLOSURE

An embodiment of the present disclosure will be described below.

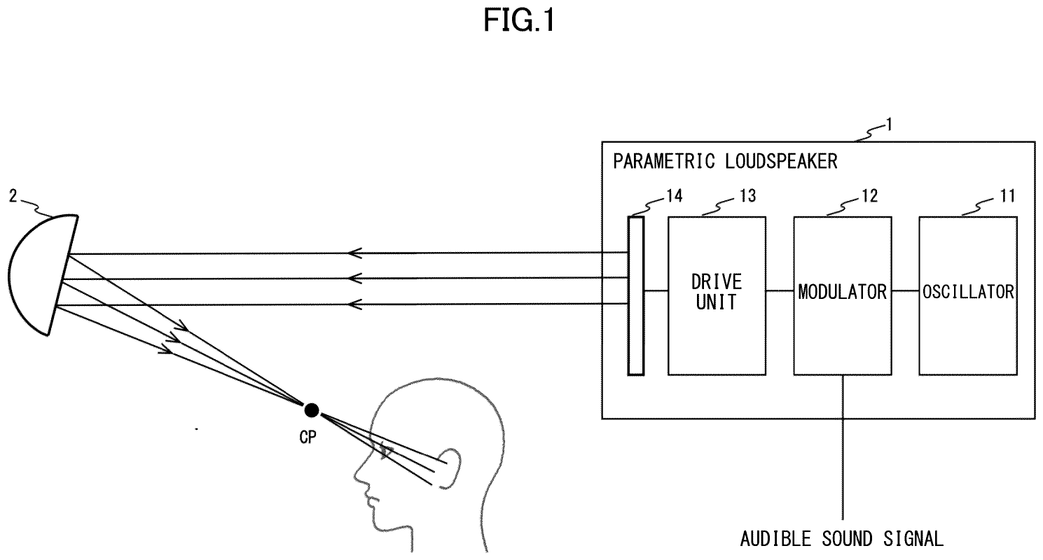

FIG. 1 shows the configuration of an acoustic system according to the present embodiment. As shown in the drawing, the acoustic system includes a parametric loudspeaker 1 and an audible sound collector 2.

The parametric loudspeaker 1 includes an oscillator 11 that generates a carrier signal that is an alternating signal having a frequency in the ultrasound range (for example, 40 kHz), a modulator 12 that amplitude-modulates the carrier signal with an input audible sound signal, a drive unit 13, and an ultrasonic transducer array 14. The drive unit 13 drives the ultrasonic transducer array 14 with a drive signal obtained by subjecting the modulated signal amplitude-modulated by the modulator 12 to amplification and phase adjustment for control of the directivity direction, to cause an amplitude-modulated ultrasonic wave to be emitted from the ultrasonic transducer array 14 in a predetermined directivity direction with a high directivity.

The directivity direction of the amplitude-modulated ultrasonic wave emitted from the ultrasonic transducer array 14 is the direction toward the audible sound collector 2, and the amplitude-modulated ultrasonic wave and the audible sound self-demodulated from the ultrasonic wave while being present in a space become incident to the audible sound collector 2.

Of the ultrasonic wave and the audible sound that have become incident, the audible sound collector 2 attenuates the ultrasonic wave, and reflects the audible sound to collect the audible sound at a sound collection position CP near the user.

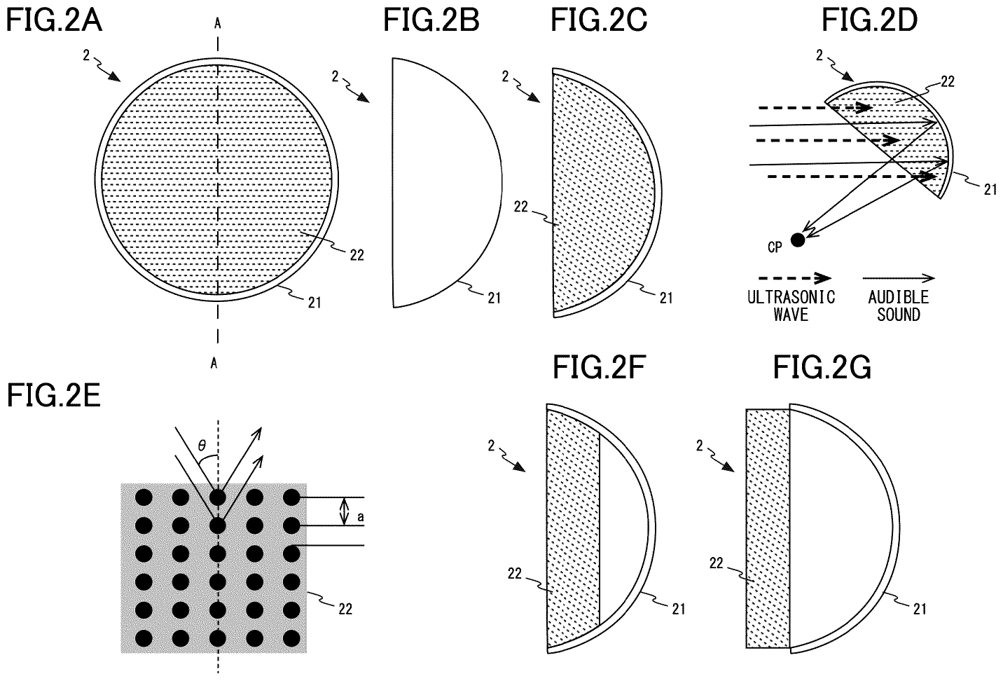

FIGS. 2A to 2G show an example of the configuration of the audible sound collector 2.

As shown in FIG. 2A, the audible sound collector 2 includes a reflector 21 having a reflecting surface formed by a paraboloid of revolution, and a sound absorber 22 for absorbing an ultrasonic wave.

Here, FIG. 2A shows the shape of the audible sound collector 2 as viewed from a side, in the direction of the rotational axis of the paraboloid of revolution, to which the paraboloid of revolution is opened. FIG. 2B shows the shape of the audible sound collector 2 as viewed in a direction perpendicular to the rotational axis of the paraboloid of revolution. FIG. 2C shows a cross-section of FIG. 2A along a line A-A.

As shown in the drawings, the reflector 21 has the shape of a parabolic antenna, and the sound absorber 22 is situated on a concave part on the inner side of the reflecting surface so as to cover the reflecting surface.

The sound absorber 22 has a function of absorbing an incident ultrasonic wave or reflecting an incident ultrasonic wave so as not to reach the reflecting surface, and a function of transmitting an incident audible sound.

Therefore, as shown in FIG. 2D, of an incident ultrasonic wave and an incident audible sound, the audible sound collector 2 can reflect only the audible sound so as to be collected and amplified at the sound collection point CP near the user to increase the magnitude of the audible sound to be heard by the user, and can inhibit the ultrasonic wave to be radiated to the user.

For example, the gain through a parabolic antenna is:

G=(πd/λ)²e_{A}
where “d” represents diameter, “λ” represents wavelength, and “e_{A}” represents coefficient (aperture efficiency).

Therefore, when the diameter of the reflecting surface is 15 cm, the gain of a 1 kHz audible sound is GA=1.92e_{A}.

When the sound absorber 22 is omitted, the gain of the carrier wave, which is a 40 kHz ultrasonic wave, is GC=3,073.58e_{A}, and the ultrasonic wave is radiated to the user while being amplified much more, i.e., 1,600 times (32 dB) more than the audible sound is amplified, is radiated to the user. In this embodiment, in which the sound absorber 22 is provided, radiation of such a greatly amplified ultrasonic wave is inhibited.

In this embodiment, as in a case of an offset parabolic antenna, the sound collection point CP of the audible sound collector 2 is set in a direction obliquely deviated from the direction of incidence of the modulated ultrasonic wave, such that the incidence of the modulated ultrasonic wave to the audible sound collector 2 is not obstructed by the user.

As the sound absorber 22, for example, a sound absorbing material made of a phononic crystal can be used.

In the case of using a phononic crystal, the center frequency fc of a sound wave reflection range is as follows.

fc=nC/(2a cos θ)
where “a” represents a structure cycle, and “θ” represents the incidence angle of a sound wave as shown in FIG. 2E, “C” represents the sound speed, and “n”=1, 2, 3, . . . .

Therefore, for example, provided that the sound speed “C” is 340 m/s and the structure cycle “a” is 4 mm, by positioning the sound absorber 22 such that the incidence angle “θ” becomes 0°, it is possible to obtain a center frequency fc of 42.5 kHz at n=1.

Therefore, in the case where the 40 kHz carrier wave is used, it is possible to reflect the ultrasonic wave that is incident to the audible sound collector 2 so as for the ultrasonic wave to not reach the reflecting surface, with the use of the sound absorbing material made of a phononic crystal as the sound absorber 22.

In the case where the 40 kHz carrier wave is used, even when the incidence angle θ is not 0°, by setting the structure cycle “a” such that nC/(2acosθ) becomes approximately 40 kHz, it is possible to reflect the ultrasonic wave that is incident to the audible sound collector 2 so as for the ultrasonic wave to not reach the reflecting surface, and to obtain a similar center frequency fc of a sound wave reflection range.

Here, the sound absorber 22 is not limited to the sound absorbing material made of a phononic crystal, and any sound absorbing material that absorbs ultrasonic waves may be used, such as a sound absorbing material having a cell structure for absorbing ultrasonic waves, other acoustic metamaterials, and the like.

Further, the sound absorber 22 may be situated in any way as long as the reflecting surface seems to be covered by the sound absorber 22 when seen from the incident side, and may be situated only on the opening side of the concave part on the inner side of the reflecting surface as shown in FIG. 2F, or may be situated in front of the reflector 21 as shown in FIG. 2G.

As the sound absorber 22, a sound absorber 22 composed of closed resonance tubes can be used.

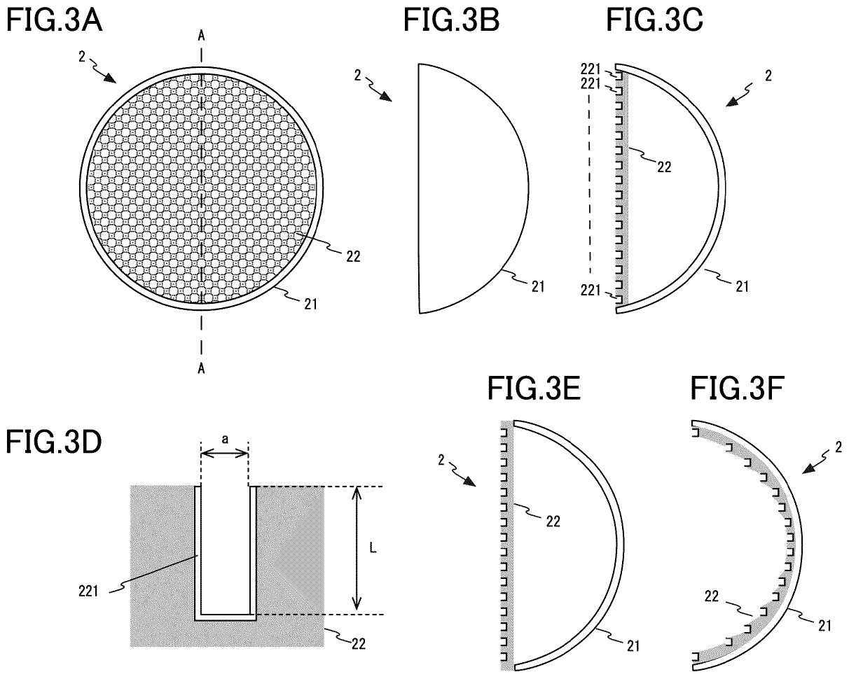

Here, when a sound absorber 22 composed of closed resonance tubes is used, the shape of the audible sound collector 2 as viewed from the side, in the direction of the rotational axis of the paraboloid of revolution, to which the paraboloid of revolution is opened, is as shown in FIG. 3A, the shape of the audible sound collector 2 as viewed in the direction perpendicular to the rotational axis of the paraboloid of revolution is as shown in FIG. 3B, and a cross-section of FIG. 3A along the line A-A is as shown in FIG. 3C.

As shown in the drawings, the audible sound collector 2 has a configuration in which the sound absorber 22 composed of an array of closed resonance tubes 221 is situated so as to cover the opening of the concave part on the inner side of the reflecting surface of the reflector 21.

When the length of a closed tube is defined as “L” and the tube diameter is defined as “a” as shown in FIG. 3D, the length L of a closed tube having characteristic vibration having a wavelength “λ” is L=λ/4. The tube diameter “a” must satisfy a≤0.586λ with respect to the wavelength “λ”. When the characteristic vibration needs to have the wavelength λ of the 40 kHz carrier wave provided that the sound speed “C” is 340 m/s, it is necessary, from λ=C/fc, that the tube length L is L=C/fc/4=0.002125, which is approximately 2.1 mm. The tube diameter may be approximately 4.9 mm or less, from a≤0.586λ=0.004891.

Therefore, using the sound absorber 22 in which the resonance tubes 221 having the length of approximately 2.1 mm and the tube diameter of 4.9 mm or less are arrayed, it is possible to reflect the ultrasonic wave incident to the audible sound collector 2 so as for the ultrasonic wave to not reach the reflecting surface.

In the case of using the sound absorber 22 composed of the resonance tubes 221 as well, the sound absorber 22 may be situated in any way as long as the reflecting surface seems to be covered by the sound absorber 22 when seen from the incident side, and may be situated in front of the reflector 21 as shown in FIG. 3E, or may be situated so as to cover the reflecting surface as shown in FIG. 3F.

Thus, the acoustic system of the present disclosure has been described.

Here, this acoustic system is applicable to various systems.

Here, as an example, an application of the acoustic system to an In Car Communication (ICC) system supporting voice communication between users in the vehicle interior of an ordinary traveling car is presented.

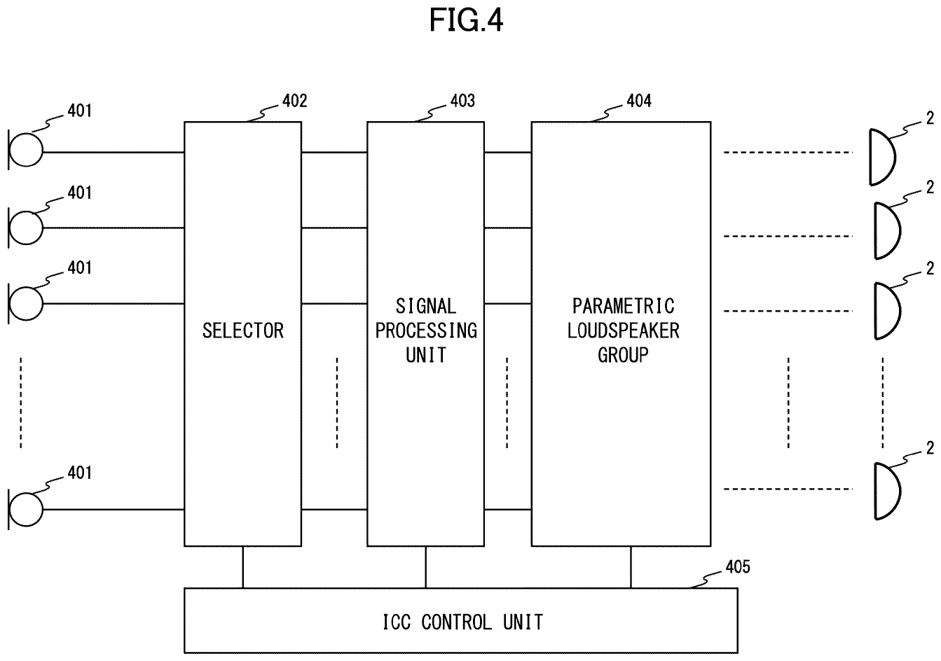

FIG. 4 shows the configuration of the ICC system.

As shown, the ICC system includes a plurality of microphones 401, a selector 402, a signal processing unit 403, a parametric loudspeaker group 404 composed of one, or a plurality of parametric loudspeakers 1, an ICC control unit 405, and a plurality of audible sound collectors 2. Here, the parametric loudspeaker group 404 part and the plurality of audible sound collectors 2 part are the components corresponding to the above-described acoustic system.

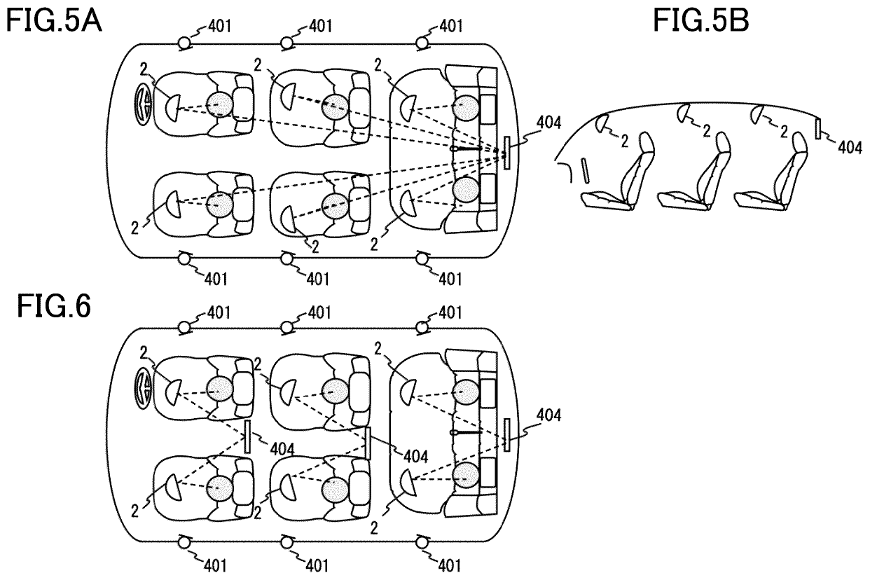

As shown in FIG. 5A, for example, the plurality of microphones 401 are provided correspondingly to the respective seats of the traveling car, and each of them is situated near the corresponding seat so as to pick up an uttered voice of the user seated in the corresponding seat. However, the microphones 401 may be provided so as to be shared among a plurality of seats, like, for example, one microphone per row of seats.

Further, the parametric loudspeaker group 404 is situated, for example, in the rear part of the vehicle interior, and the plurality of audible sound collectors 2 are provided correspondingly to the respective seats, and each of them is provided in front of the corresponding seat. Each audible sound collector 2 reflects rearward, an audible sound self-demodulated from an ultrasonic wave emitted from the parametric loudspeaker group 404 toward itself while being amplitude-modulated with the audible sound, to collect the reflected audible sound toward the user seated in the corresponding seat.

Here, as shown in FIG. 5B, the parametric loudspeaker group 404 and the plurality of audible sound collectors 2 can be situated on the ceiling in the vehicle interior.

Returning to FIG. 4, the ICC control unit 405 controls an operation for emitting an ultrasonic wave amplitude-modulated with a sound that is input via any one or more microphones 401 following a previously set handling or a handling selected by a user, to any one or more audible sound collectors.

For example, when emitting an ultrasonic wave amplitude-modulated with a sound input via the i-th microphone 401 to the j-th audible sound collector 2, the selector 402 is controlled to emit the output from the i-th microphone 401 to the signal processing unit 403 as a sound i, such that the signal processing unit 403 applies echo cancellation and gain adjustment to the sound i, and outputs it to the parametric loudspeaker group 404. Then, in the parametric loudspeaker group 404, the parametric loudspeaker 1 that has its directivity direction in a direction to the j-th audible sound collector 2 amplitude-modulates an ultrasonic carrier wave with the sound i and emits it to the j-th audible sound collector 2.

As the parametric loudspeaker 1 having its directivity direction in the direction to the j-th audible sound collector 2, the parametric loudspeaker 1 having its directivity direction in the direction to the j-th audible sound collector 2 may be used from among parametric loudspeakers 1 prepared in advance to have their directivity directions fixedly in the directions to the corresponding audible sound collectors 2, or a parametric loudspeaker 1 prepared to have a changeable directivity direction may be used with its directivity direction controlled by the ICC control unit 405 to be in the direction to the j-th audible sound collector 2 when emitting an amplitude-modulated ultrasonic wave to the j-th audible sound collector 2.

Similarly, when emitting an ultrasonic wave amplitude-modulated with a sound that is input via the i-th microphone 401 to the j-th, k-th, m-th, and n-th audible sound collectors 2, the selector 402 is controlled to emit the output from the i-th microphone 401 to the signal processing unit 403 as the sound i, such that the signal processing unit 403 applies echo cancellation and gain adjustment to the sound i and outputs it to the parametric loudspeaker group 404. Then, four parametric loudspeakers 1, in the parametric loudspeaker group 404, that have their directivity directions in the directions to the j-th, k-th, m-th, and n-th audible sound collectors 2 amplitude-modulate an ultrasonic carrier wave with the sound i and emit it to the j-th, k-th, m-th, and n-th audible sound collectors 2.

Here, as the parametric loudspeakers 1 having their directivity directions in the directions to the j-th, k-th, m-th, n-th, and . . . -th audible sound collectors 2, the parametric loudspeakers 1 having their directivity directions in the directions to the j-th, k-th, m-th, n-th, and . . . -th audible sound collectors 2 may be used from among parametric loudspeakers 1 prepared in advance to have their directivity directions fixedly in the directions to the corresponding audible sound collectors 2, or parametric loudspeakers 1 in a number the same as the number of the j-th, k-th, m-th, n-th, and . . . -th audible sound collectors 2 may be used with their directivity directions controlled by the ICC control unit 405 to be in the directions to the j-th, k-th, m-th, n-th, and . . . -th audible sound collectors 2 from among parametric loudspeakers 1 having changeable directivity directions, prepared in the same number as a number assumable as the number of audible sound collectors 2 to be used at the same time, when emitting an amplitude-modulated ultrasonic wave to the j-th, k-th, m-th, n-th, and . . . -th audible sound collectors 2.

Next, an operation for emitting an ultrasonic wave amplitude-modulated with sounds that are input via the a-th, b-th, c-th, d-th, and . . . -th microphones 401 to the j-th audible sound collector 2 or to the j-th, k-th, m-th, n-th, and . . . -th audible sound collectors 2 is a version of the above-described operation in which the parametric loudspeakers 1 amplitude-modulate an ultrasonic carrier wave not with the sound input via the i-th microphone 401, but with a sound synthesized by the signal processing unit 403 from the sounds input via the a-th, b-th, c-th, d-th, and . . . -th microphones 401.

Here, as described above, the number of parametric loudspeakers 1 required in the parametric loudspeaker group 404 is the number assumable as the number of audible sound collectors 2 to be used at the same time when parametric loudspeakers 1 having changeable directivity directions are used, and is the number assumable as the number of audible sound collectors 2 that have the probability of being used, regardless of whether or not they are used at the same time when parametric loudspeakers 1 having fixed directivity directions are used.

However, with the use of a parametric loudspeaker 1 to which a plurality of changeable directivity directions can be set, the same parametric loudspeaker 1 may be used in common to two or more audible sound collectors 2, when there are a plurality of audible sound collectors 2 to be used at the same time.

In this ICC system, when a plurality of parametric loudspeakers 1 are included in the parametric loudspeaker group 404, the respective parametric loudspeakers 1 may be situated at different positions. For example, as shown in FIG. 6, the parametric loudspeaker 1 for audible sound collectors corresponding to the seats on the first row may be provided on the back of the seats on the first row, the parametric loudspeaker 1 for audible sound collectors corresponding to the seats on the second row may be provided on the back of the seats on the second row, and the parametric loudspeaker 1 for audible sound collectors corresponding to the seats on the third row may be provided on the back of the seats on the third row.

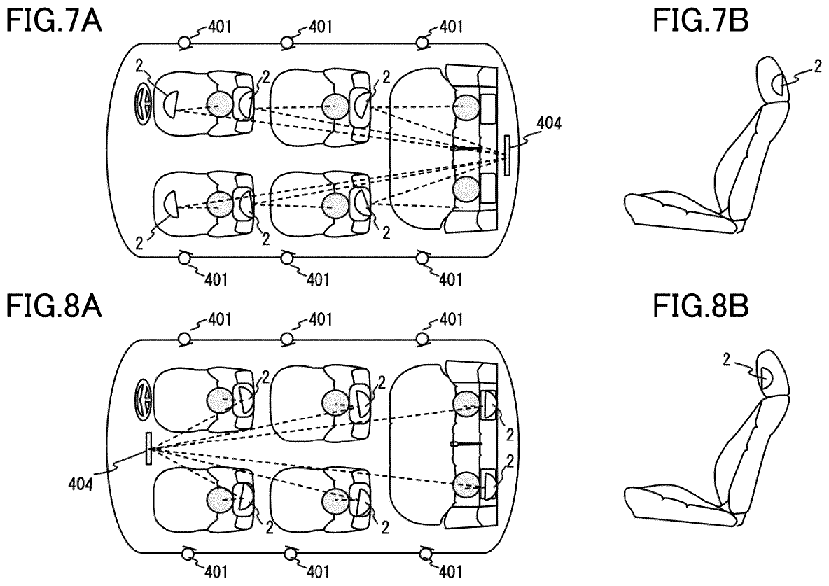

At least one or some of the audible sound collectors 2 may be situated on a seat or seats. For example, as shown in FIGS. 7A and 7B, the audible sound collectors 2 corresponding to the seats on the second row may be provided on the headrests of the seats on the first row and the audible sound collectors 2 corresponding to the seats on the third row may be provided on the headrests of the seats on the second row.

Further, as shown in FIG. 8A, the parametric loudspeaker group 404 may be situated on a front part in the vehicle interior, and the audible sound collectors 2 corresponding to the respective seats may be situated on a back part of the respective seats, such that the audible sound collectors 2 may reflect forward, an audible sound self-demodulated from an ultrasonic wave that is emitted from the parametric loudspeaker group 404 toward themselves while being amplitude-modulated with the audible sound, to collect the reflected audible sound toward the users seated in the corresponding seats.

In this example, as shown in FIG. 8B, the audible sound collectors 2 corresponding to the respective seats are provided on the headrests of the seats.

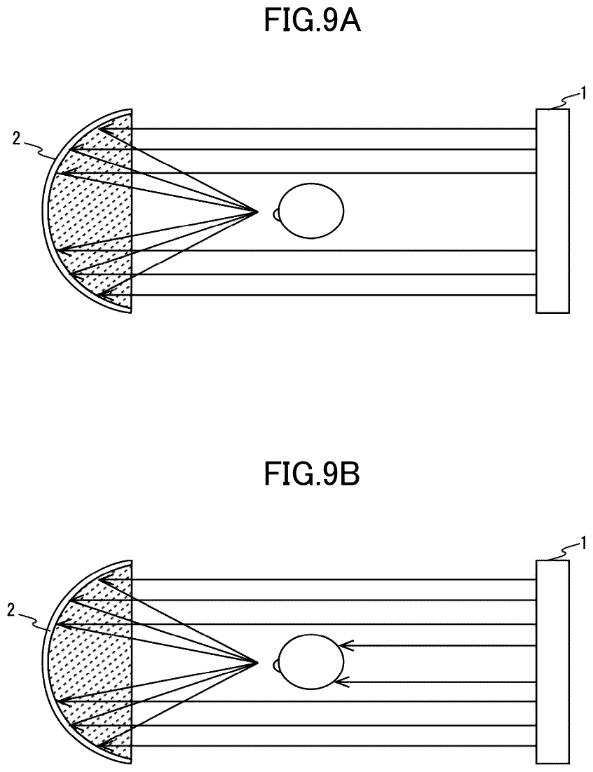

Next, as shown in FIGS. 9A and 9B, the acoustic system according to this embodiment may be configured such that the parametric loudspeaker 1 and the audible sound collector 2 are arranged coaxially, and the audible sound collector 2 collects an audible sound at a position near the user existing between the parametric loudspeaker 1 and the audible sound collector 2.

FIG. 9A shows a case where a modulated ultrasonic wave is emitted to the audible sound collector 2 by bypassing the user, and FIG. 9B shows a case where a modulated ultrasonic wave is emitted to the audible sound collector 2 while being permitted to be partially radiated to the user.

Even in the case of FIG. 9B, it can be expected that the audible sound heard by the user is predominated by the audible sound collected by the audible sound collectors 2, with the level of direct waves of the audible sound being low. In addition, only a limited part of the emitted ultrasonic wave is radiated to the user.

In the above-described embodiment, the reflecting surface of the reflector 21 is a paraboloid of revolution. However, the reflecting surface may have a shape capable of collecting an appropriate audible sound in accordance with the incidence angle of a modulated ultrasonic wave and widening of the incidence angle. That is, the shape of the reflecting surface may be, for example, an ellipsoid of revolution or any other concave surface.

What is claimed is:

1. An acoustic system including a parametric loudspeaker configured to emit an ultrasonic wave modulated with an audible sound as an emitted sound wave, the acoustic system comprising:
an audible sound collector to which the emitted sound wave emitted by the parametric loudspeaker becomes incident,
wherein the audible sound collector includes:
a reflector having a reflecting surface configured to reflect a sound wave that becomes incident thereto in a same direction as a direction in which the emitted sound wave becomes incident thereto; and
a sound absorber,
wherein the sound absorber is positioned closer to a side from which the emitted sound wave becomes incident than the reflecting surface of the reflector is, and is configured to attenuate an ultrasonic wave component of the emitted sound wave reaching the reflecting surface, and
wherein the reflecting surface of the reflector reflects an audible sound component that is self-demodulated by the emitted sound wave and becomes incident to the audible sound collector, to cause the audible sound component to be collected at a predetermined sound collection position.

2. The acoustic system according to claim 1,
wherein the reflecting surface of the reflector has a shape of a paraboloid of revolution.

3. The acoustic system according to claim 1,
wherein the sound absorber is a sound absorbing material made of a phononic crystal for absorbing an ultrasonic wave.

4. The acoustic system according to claim 1,
wherein the sound absorber includes a plurality of closed resonance tubes configured to absorb an ultrasonic wave.

5. The acoustic system according to claim 1,
wherein the sound collection position is located in a direction deviated from the direction in which the emitted sound wave becomes incident to the audible sound collector.

6. An in-vehicle communication support system mounted on an automobile, comprising:
the acoustic system of claim 1; and
a microphone configured to collect uttered voice of a user seated in a first seat of the automobile,
wherein the parametric loudspeaker emits an ultrasonic wave modulated with the uttered voice collected by the microphone as an emitted sound wave, and
wherein the sound collection position at which the audible sound collector of the acoustic system collects the audible sound component is a position near a user seated in a second seat of the automobile.
